(19) United States
(12) Patent Application Publication
(10) Pub. No.: US 2026/0062271 A1
(43) Pub. Date: Mar. 5, 2026

(54) POLE PULLING DEVICE AND METHOD OF OPERATING THEREOF

(71) Applicant: NEULS HOLDINGS INC., Craven (CA)

(72) Inventor: Jarrett NEULS, Craven (CA)

(21) Appl. No.: 19/199,663

(22) Filed: May 6, 2025

Related U.S. Application Data
(60) Provisional application No. 63/688,983, filed on Aug. 30, 2024.

(51) Int. Cl. B66F 19/00

(52) U.S. Cl. CPC B66F 19/00

(57) ABSTRACT

Examples herein generally relate to a pole pulling device and a method of operating thereof. The pole pulling device includes a support frame; a clamping mechanism coupled to the support frame, and comprising at least two clamp members for engaging an elongate pole, wherein the clamping mechanism is operable to move between an expanded position to receive the pole, and a contracted position to securely engage the pole; and a ramming mechanism coupled to the support frame, and comprising at least one ramming assembly, wherein after the clamping mechanism engages the pole, the ramming mechanism is operable to translate from a retracted state to an expanded state to apply axial force to extract the pole from a surface.

### CROSS-REFERENCE TO RELATED APPLICATION(S)

This application claims priority to, and the benefit of, U.S. Provisional Patent Application No. 63/688,983, filed on Aug. 30, 2024, titled “Pole Pulling Device and Method of Operating Thereof,” the contents of which are hereby incorporated by reference in their entirety.

### FIELD

Various examples are described herein that generally relate to devices and other apparatus for pulling poles from ground (e.g., electric, light and other utility poles), and in particular, to a pole pulling device and a method of operating thereof.

### BACKGROUND

Poles (e.g., utility poles) are often buried deep into ground to ensure they are positionally secure. This makes it difficult to extract the poles from ground, such as to remove or replace the poles. The difficulty of extracting poles increases during the winter season when the poles are buried deep into frozen ground. In many cases, large and heavy machinery is required to apply the necessary pulling force to extract the poles from ground, especially during the winter season.

### SUMMARY

In at least one broad aspect, there is provided a pole pulling device, comprising: a support frame; a clamping mechanism coupled to the support frame, and comprising at least two clamp members for engaging an elongate pole, wherein the clamping mechanism is operable to move between an expanded position to receive the pole, and a contracted position to securely engage the pole; and a ramming mechanism coupled to the support frame, and comprising at least one ramming assembly, wherein after the clamping mechanism engages the pole, the ramming mechanism is operable to translate from a retracted state to an expanded state to apply axial force to extract the pole from a surface.

In some examples, the ramming assembly has a telescoping design comprising a ram member that axially telescopes relative to a ram housing.

In some examples, the ram housings are coupled to the clamp members.

In some examples, the clamp members include a static clamp member and a moveable clamp member, and the moveable clamp member translates relative to the static clamp member between the expanded and contracted positions.

In some examples, the one of the ram housings is moveable, with the moveable clamp member.

In some examples, the ramming mechanism further includes a hydraulic piston assembly coupled to each ramming assembly.

In some examples, the device further includes a ramming actuation system for controlling the hydraulic piston assembly, the clamping actuation system comprising one or more controllable valves.

In some examples, the clamping mechanism further includes a hydraulic piston assembly coupled to the moveable clamp member.

In some examples, a clamping actuation system for controlling the hydraulic piston assembly, the clamping actuation system comprising one or more controllable valves.

In some examples, the device further comprising a rotation mechanism for rotating the clamping and ramming mechanisms.

In some examples, the support frame comprises a rotating support plate and a mounting support plate, and the rotation mechanism is interposed between the two plates and rotates the rotating support plate relative to the mounting support plate, and wherein the clamping and ramming mechanisms are coupled to the rotating support plate.

In some examples, the rotation mechanism includes at least two hydraulic piston assemblies coupled to a rotating axle extending between the rotating and mounting support plates.

In another broad aspect, there is provided a method of operating a pole pulling device of any of the preceding paragraphs, comprising: operating the clamping mechanism from an expanded position into a contracted position to engage around the pole; and operating the ramming mechanism from a retracted state into an extended state to extract the pole from a surface.

In some examples, the method further comprises operating the rotation mechanism to rotate the rotating support plate.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIGS. 1A and 1B illustrate an example pole pulling device mounted onto a construction vehicle and engaging a pole structure (FIG. 1A), and further pulling the pole structure from ground (FIG. 1B);

FIG. 2A is a perspective view of the pole pulling device, and with a ramming mechanism of the device in a retracted state;

FIG. 2B is a perspective view of the pole pulling device, and with the ramming mechanism in an extended state;

FIG. 2C is a rear view of the pole pulling device;

FIGS. 3A and 3B are partial closeup views of the pole pulling device, further illustrating a clamping mechanism of the device;

FIGS. 3C and 3D are schematic illustrations of a top view of the pole pulling device, and illustrating the clamping mechanism in different clamping states;

FIG. 4A is a perspective view of the pole pulling device in a rotated position;

FIG. 4B is a closeup perspective sideview of the pole pulling device, and illustrating a rotation mechanism of the device;

FIG. 4C is a perspective view of the rotation mechanism;

FIGS. 4D and 4E illustrate the rotation mechanism in an unrotated state (FIG. 4D) and a rotated state (FIG. 4E);

FIG. 5 is an example method for operating the pole pulling device; and

FIG. 6 is a simplified hardware block diagram for a system for operating the pole pulling device.

Further aspects and features of the example embodiments described herein will appear from the following description taken together with the accompanying drawings.

### DETAILED DESCRIPTION

Examples herein generally relate to a pole pulling device and a method of operating thereof.

### I. General Overview

As noted in the background, large and heavy machinery is typically required to extract utility poles from ground. This is especially the case where the poles are implanted deep into frozen ground, such as during the winter season. In many cases, dedicated machinery is either not available or is otherwise expensive to acquire.

In view of the foregoing, disclosed examples provide for a pole pulling device. The pole pulling device can extract utility poles, as well as other structures (e.g., beams, etc.). An advantage of the disclosed device is that it can be a modular add-on, or modular attachment. For example, the device can be removably coupled (e.g., mounted) and interfaced with a construction vehicle, such as a skid steer loader or other types of compact loaders. Accordingly, use of the device obviates the need for dedicated and expensive machinery to extract poles. In other examples, the device is a modular or permanent (e.g., integral) add-on to any other type of mobile or stationary machine, object or otherwise.

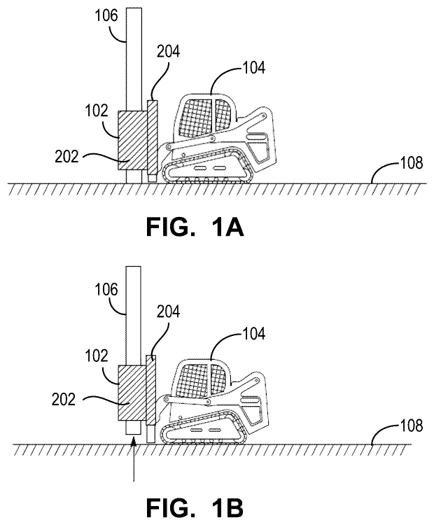

FIGS. 1A and 1B illustrate an example pole pulling device 102, in accordance with disclosed examples.

As shown, the pole pulling device 102 may be couplable to a construction vehicle 104, such as a skid steer loader or other type of compact loader. In some examples, the device 102 is a front-end attachment to the vehicle 104, as shown. In other examples, however, the device 102 can be coupled to any other portion of the vehicle 104.

As shown in FIG. 1A, the device 102 uses a clamping mechanism 202 to clamp (e.g., grip, couple or engage) around a utility pole 106 implanted into ground 108 or any other surface. Clamping mechanism 202 ensures that the device 102 securely engages the utility pole 106.

Once engaged, as shown in FIG. 1B, a ramming mechanism 204 is operated to apply an upward force to pull (e.g., lift or extract) the pole 106 out of ground 108. As explained herein, the ramming mechanism 204 operates by engaging downwardly onto the ground 108 to generate a counter upward force, that pulls the pole 106 out of ground 108.

While not shown in FIGS. 1A and 1B, after the pole is extracted from ground 108, the device 102 is also operable to rotate such as to re-orient the pole 106 from a vertical orientation into a horizontal orientation, or any other non-vertical orientation. This rotation is effected using a rotation mechanism. The rotation facilitates resting the pole 106 on a horizontal surface, such on the ground or on a stack.

To this end, at least one advantage of the device 102 is that it includes various mechanisms—e.g., clamping, ramming and rotation mechanisms—that are hydraulically actuated using the same hydraulic oil used for controlling other attachments commonly used with skid steer and compact loader vehicles (e.g., compact loader buckets). In this manner, the pole pulling device 102 is easily interfaced as a modular add-on attachment to existing construction vehicles, and without requiring special modifications to these vehicles.

While disclosed examples explain use of the pole pulling device 102 with utility poles, it should be understood that the device 102 is operable with any other elongated structure (e.g., beam or pole) lodged into ground, or any other surface.

Various features of the disclosed pole pulling device 102 are now explained in greater detail herein.

### II. Example Pole Pulling Device

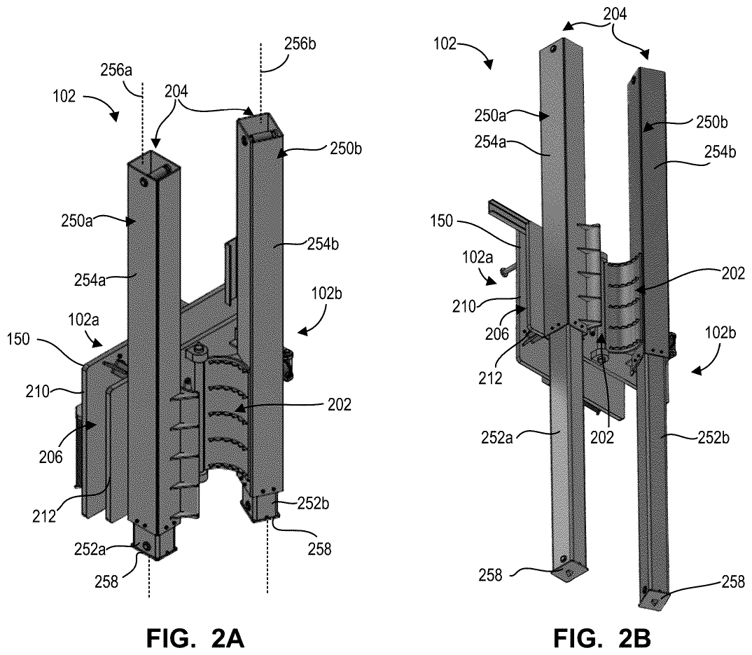

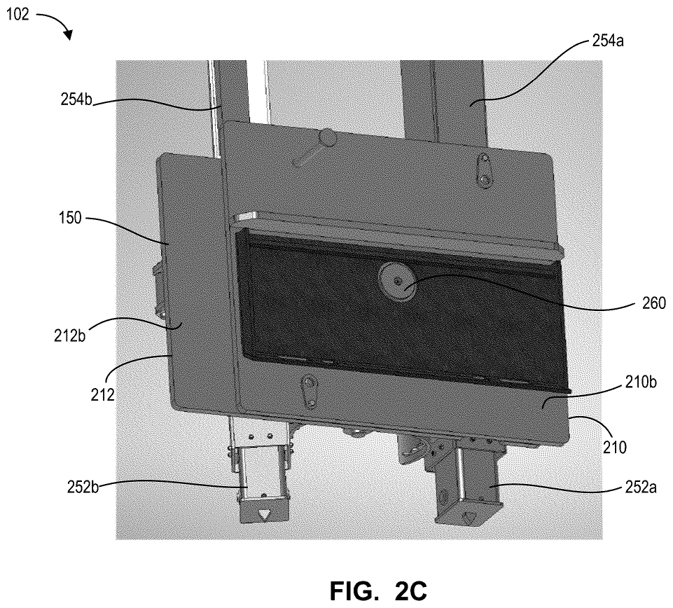

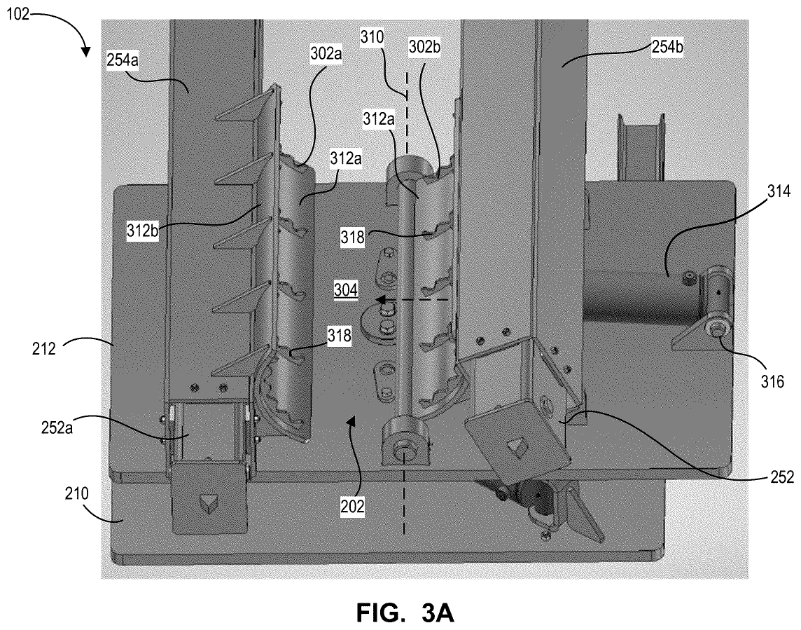

FIGS. 2A-2C provide various views an example pole pulling device 102. At a general level, the pole pulling device 102 comprises a support frame structure 150 retaining: (i) a clamping mechanism 202 for clamping around a pole 106; (ii) a ramming mechanism 204 for applying an axial force to lift the pole 106 from ground 108; and (iii) a rotation mechanism 206 for rotating the extracted pole 106 into various orientations. In some examples, the rotation mechanism 206 is not necessarily provided in the pole pulling device 102.

As shown, pole pulling device 102 also includes the support frame 150 for supporting the mechanisms 202-206, and which can comprise any suitable structure. In the exemplified embodiments, the support frame 150 includes two support members: (i) a mounting support member 210, and (ii) a rotating support member 212.

In this example, each of the support members 210, 212 comprises a plate structure, such as to define a mounting support plate 210 and a rotating support plate 212, respectively. The plates 210, 212 are axially spaced apart, and may be oriented in parallel arrangement. Mounting plate 210 can define a rearward face 102a of device 102, while rotating plate 212 can define a forward face 102b of device 102.

In disclosed examples, the mounting plate 210 is used for coupling (e.g., mounting) the device 102 to an object, machine or the like. For example, the mounting plate 210 is used to couple the pole pulling device 102 to a construction vehicle, such as a skid steer loader. As shown in FIG. 2C, a rearward face 210b of mounting plate 210 includes a mounting interface 260 to allow for coupling device 102 to another object.

In contrast to mounting plate 210, rotating plate 212 is used to retain the clamping and ramming mechanisms 202, 204. For instance, as shown in FIGS. 2A-2B, the clamping and ramming mechanisms 202, 204 are secured to a front face 212a of the rotating plate 212.

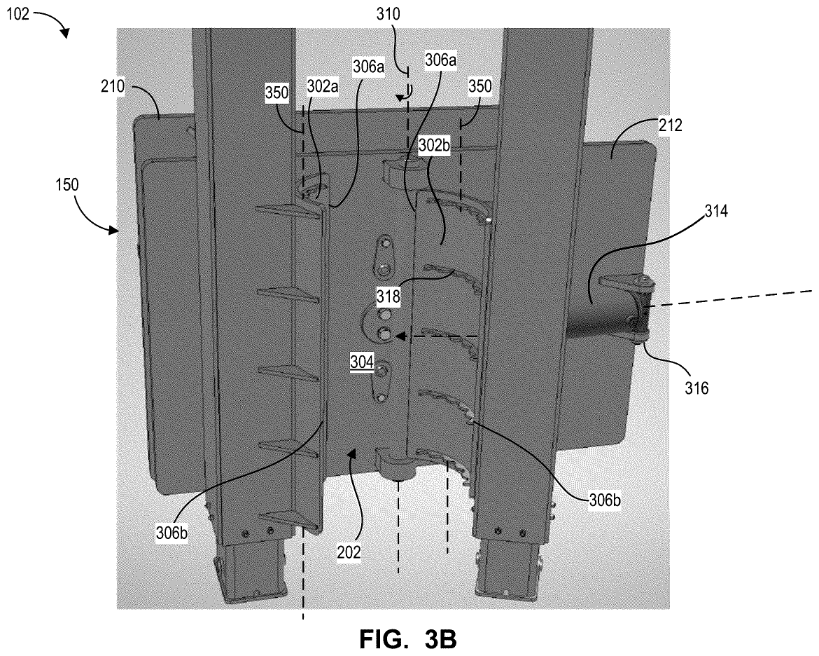

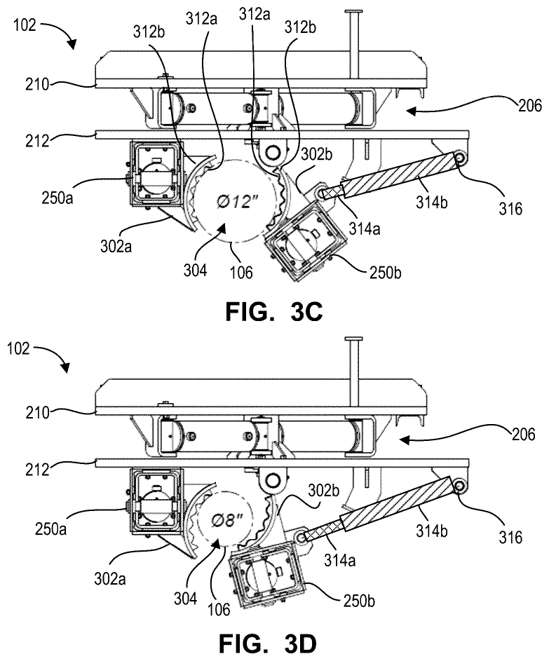

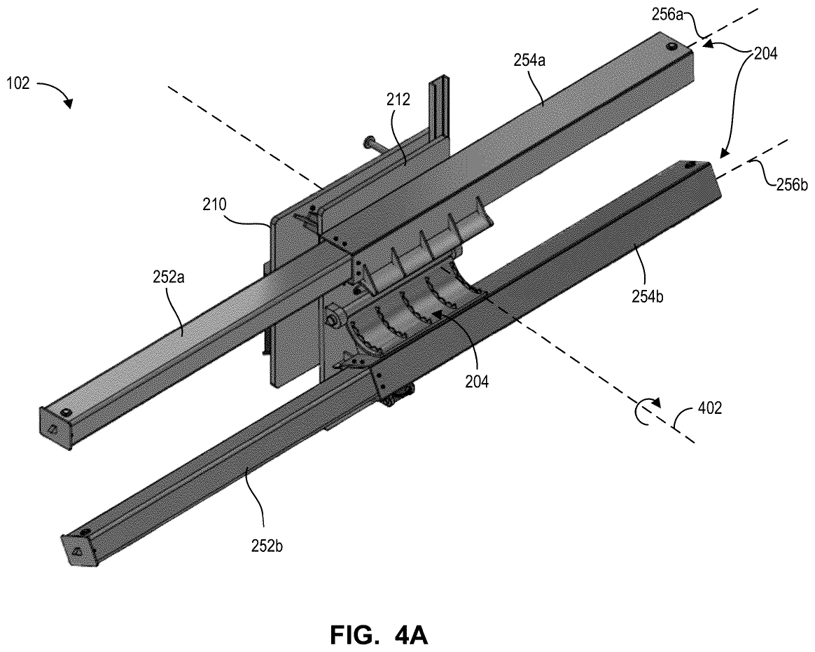

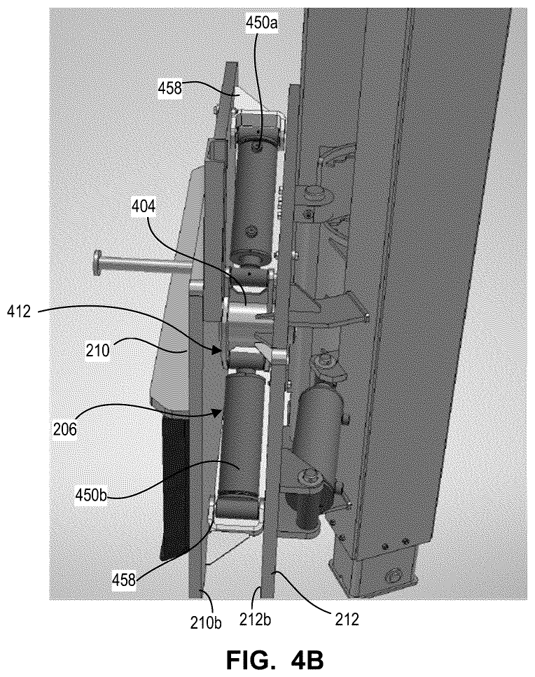

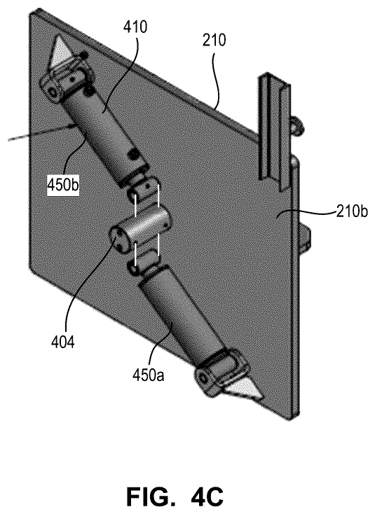

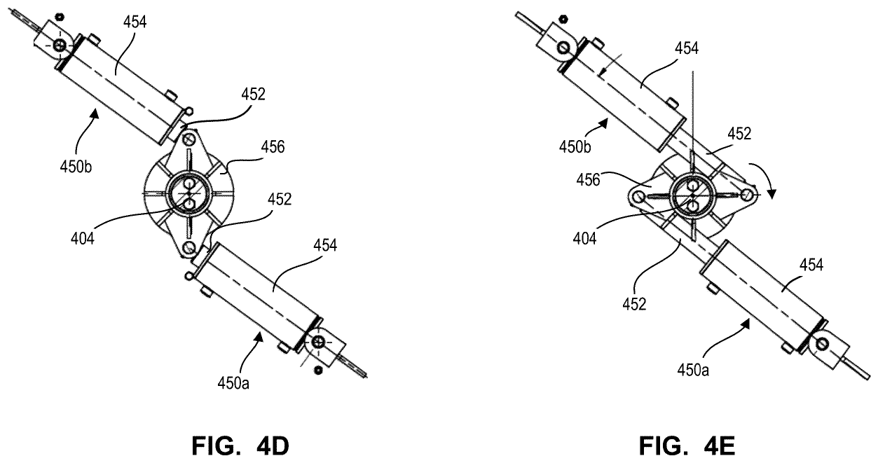

The rotating plate 212 is so named because it can rotate relative to the mounting plate 210, via the rotation mechanism 206 (see e.g., rotated plate 212 in FIG. 4A). This allows rotating an extracted pole between the vertical and horizontal orientations, or any other orientation. As exemplified in FIGS. 3C-3D and 4B, the rotation mechanism 206 is coupled between mounting plate 210 and rotating plate 212 to enable rotation of the rotating plate 212 relative to the mounting plate 210.

In some examples, the device 102 may not necessarily include the rotating mechanism 206. For example, device 102 can simply include the clamping and ramming mechanisms 202, 204, but with no rotation functionality. In these examples, it is possible that the support frame 150 only includes a single plate with (i) one side for retaining the clamping and ramming mechanisms 202, 204; and (ii) one side for including the mounting interface 260.

Each of the clamping mechanism 202, ramming mechanism 204 and rotation mechanism 206 are now explained in greater detail.

### (i.) Clamping Mechanism.

Clamping mechanism 202 is used to engage (e.g., clamp, clasp around, engage, couple to) the pole structure 106, such as to allow the pole pulling device 102 to extract the pole 106 from a surface 108.

FIGS. 3A-3D exemplify the clamping mechanism 202 in greater detail. As exemplified, the clamping mechanism 202 includes a first clamp member 302a and a second clamp member 302b. The first and second clamp members 302a, 302b engage around the pole 106 to retain and secure the pole. As shown in FIGS. 3C and 3D, a pole receiving area 304 is defined between the first and second clamp members 302a, 302b.

As exemplified in FIG. 3C, each clamp member 302 can include an opposing inner surface 312a and outer surface 312b. The inner surfaces 312a are directed towards each other, and engage the pole 106.

In some examples, the inner surfaces 312a—of one or both clamp members 302—includes engagement elements 318 (FIGS. 3A-3B). Engagement elements 318 can comprise teeth or the like, which can ensure that the clamps 302 firmly secure to the pole 106. In this manner, the clamp members 302 are uniquely adapted to securely engage various types of wooden utility poles using the teeth 318. The teeth 318 can be oriented to engage the pole at a generally normal angle to the pole surface, which helps the device 102 pull the pole 106 from ground in a vertical direction. In some examples, there may be multiple layers of teeth 318, to engage various portions along the length of the elongate pole.

In at least one example, each clamp member 302 has a generally concave arcuate profile along the inner surface 312a, and extending between an inner side 306a and an outer side 306b of the clamp member 302 (FIGS. 3A and 3B). An advantage of this configuration is to allow the clamps 302 to again more tightly engage around pole structures by having a reciprocal or corresponding circular cross-sectional profile (see e.g., FIGS. 3C and 3D). Each clamp member 302 can also extend along a parallel clamp axis 350 to also have an elongate profile suited for engaging elongate pole structures.

While the illustrated examples show only two clamp members, it will be understood that more than two clamp members may be provided. For example, it is possible that each clamp member 302a, 302b is itself segmented into more than one clamp member.

In the exemplified embodiments, the clamping mechanism 202 is operable to translate between an expanded position (FIGS. 3A and 3B) and a contracted position (FIGS. 3C and 3D).

In the expanded position (FIGS. 3A and 3B), the clamp members 302a, 302b are spaced apart to define a larger pole receiving area 304. This allows the pole pulling device 102 to receive a pole 106 inside the clamping mechanism 202.

In the contracted position (FIGS. 3C and 3D), the clamp members 302a, 302b are translated towards each other to define a reduced, smaller or narrower pole receiving area 304. For example, once the pole 106 is received between the clamp members 302a, 302b—the clamping mechanism 202 is operated into the contracted position to contact and engage the pole. This allows the clamp members 302a, 302b to engage a lateral outer surface of the pole 106, thereby securing the pole 106 tightly between the clamp members 302a, 302b.

As further shown in FIGS. 3C and 3D, an advantage of the clamping mechanism 202 is that it can translate to various degrees of contracted positions, such as to accommodate different dimensioned poles (e.g., different diameters, shapes, etc.). In other words, the clamp members 302a, 302b can be brought together at different proximities to vary the size of the pole receiving area 304.

To this effect, any suitable configuration is used to translate the clamping mechanism 202 between the expanded and contracted positions. In the illustrated example, the clamping mechanism 202 includes a first static (e.g., fixed) clamp member 302a, and a second moveable (e.g., rotatable) clamp member 302b.

With respect of the static clamp 302a, the inner clamp side 306a is fixedly (e.g., rigidly) coupled to the rotatable support plate 212. In contrast, with respect of the moveable clamp 302b, the inner clamp side 306a is moveably coupled to the rotatable support plate 212, e.g., via a swinging hinge design. In this example, moveable clamp 302b rotates or swings along a rotation axis 310, which may be oriented generally vertically in the upright position.

In use, in the expanded state (FIGS. 3A and 3B), moveable clamp 302b rotates away from static clamp 302a. In the contracted state (FIGS. 3C and 3D), moveable clamp 302a rotates towards the static clamp member 302a. The moveable clamp member 302b can rotate towards the static clamp 302a by any necessary extent to engage different dimensioned poles 106.

In other examples, the movable clamp 302b can translate in any other manner. For example, rather than using a swinging hinge design, it may slide towards and away from static clamp 302a.

Any suitable mechanism can also be used to actuate rotation of the moveable clamp 302b between the retracted and expanded states. In this example, a hydraulic piston assembly 314 is used to actuate the rotation.

As shown in FIGS. 3C-3D, the hydraulic piston assembly 314 includes a piston member 314a that couples to the exterior surface 312b of movable clamp 302b. A housing 314b, of the piston assembly 314, can couple (e.g., rotatably couple) to the rotatable support plate 212 (e.g., via a rotatable attachment 316). While only a single hydraulic piston assembly 314 is illustrated, more than one hydraulic piston assembly 314 can be used to operate the movable clamp 302b.

While examples herein exemplify a configuration for the clamping mechanism 202—it is understood that device 102 can use other designs for the clamping mechanism. For example, the static and moveable clamps 302a, 302b can be swapped, or both of the clamps 302a, 302b can comprise movable clamps. In the latter case, one or more hydraulic piston assemblies may be provided for each movable clamp 302a, 302b.

### (ii.) Ramming Mechanism.

Ramming mechanism 204 is used to extract a pole 106 from ground. Once the pole 106 is secured via the clamping mechanism 202, ramming mechanism 204 applies an axial upward force on a surface in which the pole 106 is implanted. As used herein, “upward” refers to a direction opposite of the direction in which the surface is located (e.g., orthonormal to the surface).

Referring to FIGS. 2A-2B, in the illustrated example, ramming mechanism 204 comprises two ramming assemblies 250a, 250b. In other cases, ramming mechanism 204 can include one or more ramming assemblies 250 (e.g., one, two, three, etc.).

As clarified below, an advantage of using at least two ramming assemblies 250a, 250b is that sufficient upward force is applied to pull or extract a pole 106 from the surface. Using two ramming assemblies, each ramming assembly 250a, 250b is disposed on either side of the pole while it is engaged inside the clamping mechanism 202. This allows applying an upward force on either side of the extracted pole 106.

Each ramming assembly 250 can have any suitable design known in the art. In the exemplified case, the ramming assemblies 250a, 250b are each configured with a telescoping design. Each assembly 250 includes: (i) an elongated ram housing 254a, 254b, which itself retains (ii) a telescoping ram member 252a, 252b.

In use, the ram members 252 each telescope (e.g., slide-in and slide-out) of the corresponding ram housing 254. The ram members 252 each telescope between a retracted state (FIG. 2A) and an extended state (FIG. 2B). In the retracted state (FIG. 2A), ram members 252 are substantially received inside of the housing 254. In the extended state (FIG. 2B), ram members 252 extend out of the housing 254.

More generally, after the clamping mechanism 202 engages the pole 106—the ramming mechanism 204 is operated to transition from the retracted state (FIG. 2A) to the extended state (FIG. 2B). In the extended state, the ram members 252 extend (e.g., telescope) such that a ram head 258—disposed on a distal end of the ram member 252 (FIGS. 2A, 2B)—engages the ground surface. As the ramming assemblies 250a, 250b continue to extend (e.g., telescope) outwardly, they apply an axial upward force to a ground surface that “pulls”the pole 106 from the surface.

As shown in FIG. 2A, to facilitate its functionality, each ramming assembly 250 may extend along a corresponding ram axis 256a, 256b, which are generally parallel. Ram members 252 accordingly telescope in and out of the housings 254, along the corresponding axis 256.

When the pole pulling device 102 is in an upright position, each ram axis 252 can be oriented substantially vertically. In this manner, when device 102 clamps around pole 106, the ramming assemblies 250 are oriented generally parallel to the elongate pole 106 and are able to apply a parallel upward force for effective pole extraction.

The ramming assemblies 250 are operable translate between the retracted and extended state in any manner known in the art. In the illustrated example, a hydraulic piston assembly is used for controlling the ramming assemblies 250. Each hydraulic piston can include a piston rod that extends and retracts out of a piston housing. The piston rod can couple to a distal end of the ram member 252a, 252b (e.g., opposite the ram head 258). In some examples, the hydraulic pistons are housed within the ram housing 254a, 254b. For example, each ram housing 254a, 254b can include its own hydraulic piston assembly.

An advantage of using a hydraulic piston assembly is that it can be driven by the same hydraulic fluid used in conventional construction vehicles, such as compact and skid steer loaders. This allows the hydraulic piston system to easily interface with hydraulic fluid tubing.

In the illustrated example, each of the static and moveable clamps 302a, 302b are coupled to one of the ramming assemblies 250a, 250b. For instance, the static clamp 302a is coupled to the ram housing 254a, while the moveable clamp 302b is coupled to the ram housing 254b. The ram housings 254 can be coupled to the exterior surface 312b of each clamp member 302 (FIG. 3A).

In this configuration, the entire second ramming assembly 250b moves freely together with the movable clamp member 302b, between the expanded and retracted positions. An advantage of this design is that, when the clamping mechanism 202 is in the contracted position—the ramming assembly 250b is also directly adjacent the pole, by virtue of it moving with the movable clamp 302b. In this manner, the two ramming assemblies 250a, 250b are directly adjacent the pole when the clamping mechanism 202 secures the pole in the contracted position, which allows the ramming assemblies 250 to apply more direct force in pulling the pole out of the ground.

### (iii.) Rotation Mechanism.

In at least one example, the pole pulling device 102 can further including a rotation mechanism. As exemplified in FIG. 4A, the rotation mechanism is used to rotate (e.g., tilt or twist) the device 102, such that the extracted pole 106 is reoriented between the vertical position and the horizontal positions. An advantage of this feature is to allow laying down the pole, once extracted from ground.

In some examples, the rotation mechanism 206 is disposed in an axial gap 412 between the mounting plate 210 and rotating plate 212 (FIG. 4B).

As shown in FIG. 4A, using the rotation mechanism 206, the rotating support plate 212 can rotate relative to the mounting support plate 210. The rotation can occur about a rotation axis 402. Rotation axis 402 can be generally orthogonal to each of the ramming axis 256 and the clamping axis 350 (which may be parallel to each other). When the rotated, the clamping and ramming mechanisms 202, 204 rotate with the rotating plate 212.

In the exemplified embodiment, the rotation mechanism 206 includes a rotating axle 404 (FIGS. 4B and 4C). Rotating axle 404 extends, along rotation axis 402, inside the axial gap 412 between inner surfaces 210b, 212b of each of the mounting support plate 210 and rotating support plate 212 (FIG. 4B). Rotating axle 404 can rotate clockwise or counterclockwise, along rotation axis 402, to rotate the rotating support plate 212.

To control rotation of the axle 404, a rotation actuation mechanism is provided. In this example, hydraulic piston assemblies 450 are provided, which include a first and second hydraulic piston assembly 450a, 450b (FIG. 4C). In other examples, other types of actuation mechanisms can be used.

FIGS. 4D and 4E exemplify operation of the hydraulic piston assemblies 450a, 450b to actuate rotation of axle 404. As shown, each piston assembly 450 includes a piston rod 452 that couples to bracket 456 of rotating axle 404.

In an unrotated position (FIG. 4D), the piston rods 452 are retracted into their respective piston housings 454. In the rotated position (FIG. 4E), the piston rods 452 extend out of their respective piston housings 454 to actuate rotation of the bracket 456, and in turn, the axle 404. In this example, the piston assembly 450a, 450b are oriented at 180° parallel spaced offset to induce a 90° rotation of the axle 404 (thereby, rotating the rotating support plate 212). In this example, the piston housings 454 may be secured between the mounting and rotating plates 210, 212 via attachments 458 (FIG. 4B).

Here, it is appreciated again that use of hydraulic piston assemblies 450a, 450b allows the rotation mechanism 206 to operate using the same hydraulic oil fluid that is common to various compact and skid steer loaders. In other examples, however, any other suitable actuation system can be used to rotate the axle 404, thereby rotating the rotating plate 212.

### III. Example Method for Controlling System

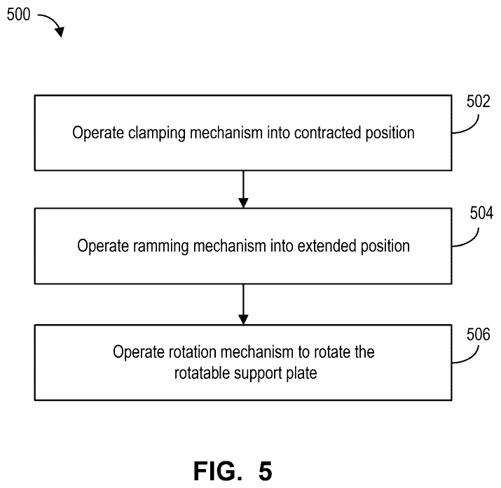

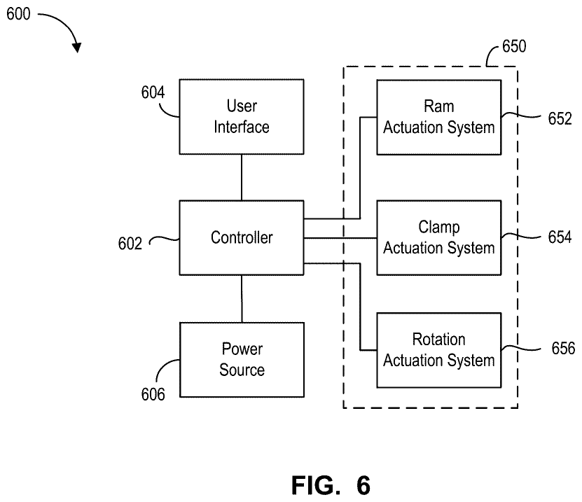

FIG. 5 shows an example method 500 for controlling the pole pulling device 102. In some examples, method 500 is executed using the controller 602 (FIG. 6).

At 502, once the pole 106 is received within the pole receiving area 304, the clamping mechanism 202 is operated to move from the expanded position (FIGS. 3A-3B) to the contracted position (FIGS. 3C-3D). In some examples, the clamping mechanism 202 is initially operated to move into the expanded position to allow the pole 106 to be received therein, before subsequently being moved into the contracted position. More generally, the clamping mechanism 202 can be controlled via a clamp actuation system, which can include one or more valves that control hydraulic fluid to the clamp hydraulic piston assembly 314 (FIG. 3A).

At 504, the ramming mechanism 204 is operated to translate the ramming assemblies from the retracted state (FIG. 2A) into the extended state (FIG. 2B). This forces the ram heads 258 to engage the ground surface, and apply a vertically upward force to pull the pole 106 out of the ground. The ramming mechanism 204 can be controlled by operating a ram actuation system, which can also include one or more valves for controlling ram hydraulic piston assemblies.

At 506, in some examples, the rotation mechanism 206 is also operated to then rotate the rotating support plate 212 from an initial orientation (e.g., vertical) to a subsequent orientation (e.g., horizontal). This control may be effected by controlling a rotation actuation system, which can include one or more valves for controlling the rotation hydraulic piston assemblies 450a, 450b (FIG. 4C).

After acts 504 or 506, the clamping mechanism 202 is further operated to release the extracted pole 106. For instance, the clamping mechanism 202 is controlled to move from the contracted state to the expanded positions. In some cases, the ram mechanism 204 is also operated to translate back to the retracted state. This can occur any time after act 504, once the pole has been extracted from ground surface. Additionally, the rotation mechanism 206 is operated back into the unrotated position.

### IV. Example Hardware Configuration

FIG. 6 is a simplified hardware block diagram for a system for operating the pole pulling device 102.

As shown, the hardware configuration includes a controller 602 coupled to the actuation system 650.

Controller 602 can include a computer processor, such as a general purpose microprocessor. In some other cases, processor may be a field programmable gate array, application specific integrated circuit, microcontroller, or other suitable computer processor. In some cases, processor may comprise multiple processors, such that is referenced as at least one processor. Controller 602 can also include a memory, that may include both volatile and non-volatile memory. Non-volatile memory stores computer programs consisting of computer-executable instructions, which may be loaded into volatile memory for execution by processor as needed.

In some examples, controller 602 may be part of a construction vehicle, such as a skid steer loader.

Actuation system 650 itself includes a ram actuation system 652, a clamp actuation system 654 and a rotation actuation system 656. In some examples, each of these actuation systems includes one or more valves, that control hydraulic fluid to the various hydraulic piston assemblies 314,450.

User interface 602 can include any form of input interface, such as keys, buttons, keyboards and the like. Power source 606 can comprise any energy storage device, including batteries.

### V. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A pole pulling device, comprising:
a support frame;
a clamping mechanism coupled to the support frame, and comprising at least two clamp members for engaging an elongate pole, wherein the clamping mechanism is operable to move between an expanded position to receive the pole, and a contracted position to securely engage the pole; and
a ramming mechanism coupled to the support frame, and comprising at least one ramming assembly, wherein after the clamping mechanism engages the pole, the ramming mechanism is operable to translate from a retracted state to an expanded state to apply axial force to extract the pole from a surface.

2. The device of claim 1, wherein the ramming assembly has a telescoping design comprising a ram member that axially telescopes relative to a ram housing.

3. The device of claim 2, wherein the ram housings are coupled to the clamp members.

4. The device of claim 3, wherein the clamp members include a static clamp member and a moveable clamp member, and the moveable clamp member translates relative to the static clamp member between the expanded and contracted positions.

5. The device of claim 4, wherein the one of the ram housings is moveable, with the moveable clamp member.

6. The device of claim 2, wherein the ramming mechanism further includes a hydraulic piston assembly coupled to each ramming assembly.

7. The device of claim 6, further including a ramming actuation system for controlling the hydraulic piston assembly, the clamping actuation system comprising one or more controllable valves.

8. The device of claim 4, wherein the clamping mechanism further includes a hydraulic piston assembly coupled to the moveable clamp member.

9. The device of claim 8, further including a clamping actuation system for controlling the hydraulic piston assembly, the clamping actuation system comprising one or more controllable valves.

10. The device of claim 1, further comprising a rotation mechanism for rotating the clamping and ramming mechanisms.

11. The device of claim 10, wherein the support frame comprises a rotating support plate and a mounting support plate, and the rotation mechanism is interposed between the two plates and rotates the rotating support plate relative to the mounting support plate, and wherein the clamping and ramming mechanisms are coupled to the rotating support plate.

12. The device of claim 11, wherein the rotation mechanism includes at least two hydraulic piston assemblies coupled to a rotating axle extending between the rotating and mounting support plates.

13. A method of operating a pole pulling device of claim 1, comprising:
operating the clamping mechanism from an expanded position into a contracted position to engage around the pole; and
operating the ramming mechanism from a retracted state into an extended state to extract the pole from a surface.

14. The method of claim 13, further comprising operating the rotation mechanism to rotate the rotating support plate.
